(19) United States
(12) Patent Application Publication
(10) Pub. No.: US 2012/0306802 A1
(43) Pub. Date: Dec. 6, 2012

(54) DIFFERENTIAL CAPACITANCE TOUCH SENSOR

(76) Inventor: David Harold McCracken, Aptos, CA (US)

(21) Appl. No.: 13/154,227

(22) Filed: Jun. 6, 2011

(51) Int. Cl. G06F 3/045

(52) U.S. Cl. 345/174; 178/18.06

(57) ABSTRACT

A touch sensor is provided. The touch sensor includes at least two capacitive sensing electrodes, each of the at least two capacitive sensing electrodes having a surface area that is smaller than an area of a touch from a user. The at least two capacitive sensing electrodes each include a substrate, a single conductive element formed on the substrate, and electronic circuitry coupled to the at least two capacitive sensing electrodes for measuring a self-capacitance of the at least two capacitive sensing electrodes. A position corresponding to the touch of a user is determined by the electronic circuitry based on a difference of the measured self-capacitance between the at least two capacitive sensing electrodes.

### BACKGROUND

1. Technical Field

The present disclosure is related to capacitive touch sensors. In particular, the present disclosure is related to capacitive touch sensors which measure a differential self-capacitance between adjacent capacitive touch sensors.

2. Discussion of Related Art

Modern electronics often include a display and require a user interface device or navigation device to interface with or navigate on the display. Such navigation devices include the well-known mice and trackballs that have been used for a long time. As modern electronics are made more portable, the displays are becoming smaller, and the need for smaller navigation devices is increasing. Some portable devices have displays that use touch screens such that the navigation is made by touching the display itself. Some portable electronics use small trackballs or optical trackballs for interfacing with a display. However, trackballs may be unreliable as debris from the environment can get into the trackball rotation surface, impeding the rotation of the trackball. Optical trackballs, which are more reliable than standard trackballs, require a thick circuit board and lens, which increases the overall thickness of a portable device. Moreover, optical trackballs require a special lens that adds to fabrication costs. Furthermore, optical trackballs require that the lens be exposed to the environment to sense a user touch and, thus, may be easily damaged from external debris.

Capacitive touch sensors have been commonly used in touch screens and as selection buttons in electronics. Conventional touch sensors based on capacitive coupling use conductive plates typically made of Indium Tin Oxide (ITO) or some other transparent material that is electrically conductive. Several conductive elements separated by a dielectric may be placed in the plane of a sensor panel to detect the position of a touch. Such capacitive touch sensors may be typically fabricated using standard semiconductor processing techniques, and can be easily mass produced. Typically, capacitive touch sensors require multiple layers of Indium Tin Oxide (ITO) and, in order to accurately measure a touch position in multiple directions, often require conductive electrodes arranged in special geometries coupled with extensive processing. Consequently, despite the relative ease in manufacturing capacitive touch sensors, the complex geometries of electrodes often required for positional accuracy makes it difficult to scale the electrode sizes down to a level that is ideal for user interface devices or navigation devices.

What is needed is capacitive touch sensor that can provide exceptional positional accuracy when detecting a touch position and is an ideal size for use as a navigational device.

### SUMMARY

Consistent with some embodiments, there is provided a touch sensor. The touch sensor includes at least two capacitive sensing electrodes, each of the at least two capacitive sensing electrodes having a surface area that is smaller than an area of a touch from a user. The at least two capacitive sensing electrodes each include a substrate, a single conductive element formed on the substrate, and electronic circuitry coupled to the at least two capacitive sensing electrodes for measuring a self-capacitance of the at least two capacitive sensing electrodes. A position corresponding to the touch of a user is determined by the electronic circuitry based on a difference of the measured self-capacitance between the at least two capacitive sensing electrodes.

Further consistent with some embodiments, there is also provided a capacitive touch sensor. The capacitive touch sensor includes at least two capacitive electrodes, the at least two capacitive electrodes each being formed on a substrate and having a single electrode layer. The at least two capacitive electrodes are arranged to oppose each other along an axis for determining a touch position along the axis and are coupled to circuitry that is configured to determine a differential self-capacitance between the at least two capacitive electrodes.

These and other embodiments will be described in further detail below with respect to the following figures.

### BRIEF DESCRIPTION OF THE DRAWINGS

FIG. 1 is a diagram illustrating a differential capacitive touch sensor system consistent with some embodiments.

FIG. 2 is a diagram illustrating a cross section of a sensor shown in FIG. 1 across line according to some embodiments.

FIG. 3A is a diagram illustrating a capacitive touch sensor consistent with some embodiments.

FIG. 3B is a diagram illustrating a partial shield formed on a bottom surface of a substrate or PCB, consistent with some embodiments.

FIGS. 4A-4G are diagrams illustrating additional exemplary electrode numbers and shapes for a capacitive touch sensor, consistent with some embodiments.

FIG. 5 is a diagram of a user holding a system having a capacitive touch sensor capable of three-dimensional position detection.

FIG. 6A is a diagram illustrating a capacitive touch sensor for measuring a touch position in three dimensions, consistent with some embodiments.

FIG. 6B is a cross-section of sensor 600 shown in FIG. 6A taken along the line VI-VI′.

FIG. 6C is a cross-section of sensor 600 shown in FIG. 6A taken along the line VI-VI′.

FIG. 7 is a diagram illustrating a capacitive touch sensor capable of detecting a touch in three dimensions, consistent with some embodiments.

FIG. 8 is a diagram illustrating a capacitive touch sensor that is also capable of detecting a pressure of a touch, consistent with some embodiments.

FIG. 9 is a diagram illustrating a touch screen having multiple differential capacitive touch sensors, consistent with some embodiments.

FIGS. 10A, 10B, and 10C are diagrams illustrating measuring the differential capacitance of adjacent differential capacitive sensors, consistent with some embodiments.

FIG. 11 is a diagram illustrating a mutual-capacitive touch screen that measures the differential capacitance of adjacent electrodes, consistent with some embodiments.

FIG. 12 is a diagram illustrating a mutual capacitance touch screen having a differential capacitance touch sensor, consistent with some embodiments.

In the drawings, elements having the same designation have the same or similar functions.

### DETAILED DESCRIPTION

In the following description specific details are set forth describing certain embodiments. It will be apparent, however, to one skilled in the art that the disclosed embodiments may be practiced without some or all of these specific details. The specific embodiments presented are meant to be illustrative, but not limiting. One skilled in the art may realize other material that, although not specifically described herein, is within the scope and spirit of this disclosure.

Touch sensors may be of a variety of types, such as resistive, capacitive, and electro-magnetic types, and may be used for numerous applications, including selection, positioning, and navigation. One particular touch sensor, capacitive touch sensor, may include a conductive material such as Indium Tin Oxide (ITO), aluminum or copper, which conducts continuous electrical current across a sensor element. Capacitive touch sensors typically exhibit a precisely controlled field of stored charge to achieve capacitance. The human body is also an electrical device which has stored charge and therefore exhibits capacitance. When a capacitive touch sensor's normal capacitance field (its reference state) is altered by another capacitance field, e.g., by the touch or near touch (hereinafter, touches will also include near touches unless otherwise noted) of a person, capacitive touch sensors measure the resultant distortion in the characteristics of the reference field and send the information about the touch event to a touch controller for mathematical processing. There are a variety of types of capacitive touch controllers, including capacitance-to-digital converters (CDC) which include Sigma-Delta modulators, charge transfer capacitive touch controllers, and relaxation oscillator capacitive touch controllers.

Conventional capacitive touch sensors use multiple electrode layers, including a transmitter electrode layer coupled to an excitation source, and a receiver electrode layer coupled to a capacitance-to-digital converter (CDC). In operation, there is an electric field formed between the transmitter electrode layer and the receiver electrode layer, as well as a stray electric field that extends from the transmitter electrode layer. The environment of the capacitive touch sensor changes when a human enters the stray electric field, with a portion of the electric field being shunted to ground instead of terminating at the receiver electrode layer, resulting in a decrease in capacitance at the receiver electrode layer. The resulting decrease in capacitance is detected by the CDC and converted to digital data which can be processed by a processor to provide an indication of a touch, a selection, or a position.

Capacitive touch sensors may also include single electrode layer capacitive touch sensors. Such single layer capacitive touch sensors include a single layer of conductive material, typically ITO, formed on an insulative substrate or printed circuit board (PCB). The single layer of conductive material forms a capacitive electrode. The single layer capacitive electrode may be protected from the environment using an overlay of protective material, which may be a plastic such as acrylonitrile-butadiene-styrene (ABS), for example. The single layer electrode may then be coupled to circuitry for reading a capacitance value from the single layer electrode. Moreover, the single layer capacitive electrode may be divided into multiple electrodes by patterning the ITO into separate electrodes, each of which may have a separate coupling to circuitry, such as a CDC, for reading determining the capacitance value on each electrode. The separate electrodes may be patterned using etching or deposition techniques. Alternatively, multiple single layer capacitive electrodes may be formed on an insulative substrate or PCB.

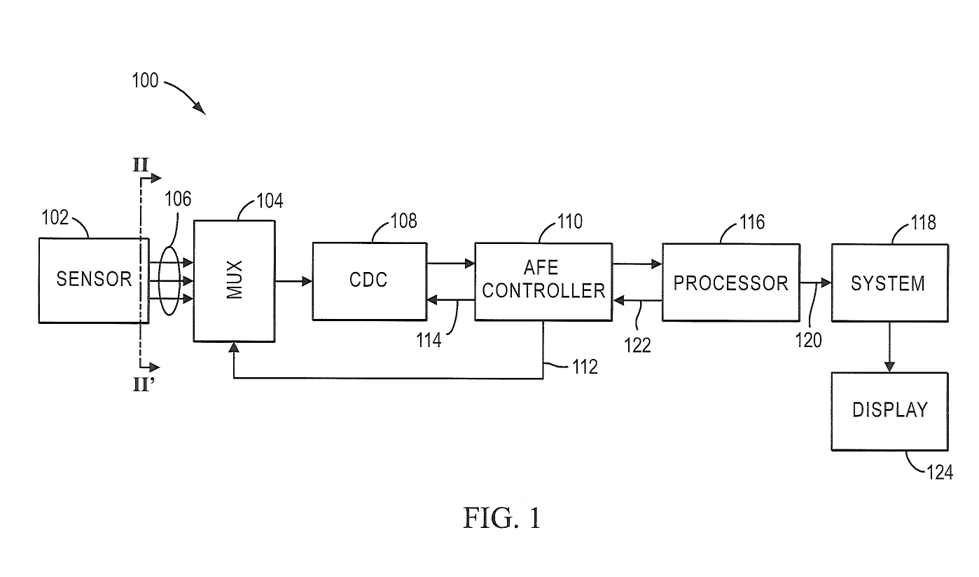

FIG. 1 is a diagram illustrating a differential capacitive touch sensor system consistent with some embodiments. As shown in FIG. 1, system 100 includes a differential capacitive touch sensor 102 that is coupled to a multiplexer 104 by one or more leads 106. According to some embodiments, capacitive touch sensor 102 is a single electrode layer capacitive touch sensor. However, according to other embodiments, capacitive touch sensor 102 may be a conventional multiple electrode layer capacitive touch sensor.

Capacitive touch sensor 102 includes multiple electrodes and, consistent with some embodiments, each lead 106 couples an individual electrode of sensor 102 to multiplexer 104. Consequently, in accordance with such embodiments, the number of leads 106 will correspond to the number of electrodes in sensor 102. However, according to other embodiments, one or more leads 106 may couple one or more electrodes of sensor 102 to multiplexer 104. Multiplexer 104 outputs a capacitance value to capacitance to digital converter (CDC) 108 which, in turn, converts the capacitance value relative to ground output by multiplexer 104 to a digital value. Consistent with some embodiments, CDC 108 coverts a capacitance value to a digital value by transferring a charge between a reference capacitor fabricated as part of CDC 108 and an electrode of sensor 102. Further consistent with some embodiments, CDC 108 provides digital conversion using a sigma-delta process to provide high resolution and high frequency noise filtering.

System 100 also includes circuitry that acts as an analog front end controller 110. Analog front end controller 110 may include a state machine and/or other logic, and provides a channel select signal 112 to multiplexer 104 for selecting a particular capacitance value from one or more leads 106 to output to CDC 108. In addition, analog front end controller may also provide a control signal 114 to CDC to control the operation of the CDC to convert the input capacitance value to a digital value. Analog front end controller 110 is coupled to, and controlled by, a processor 116. Consistent with some embodiments, processor 116 may be a microprocessor or microcontroller, and may be a separate device, such as shown in FIG. 1, or may be embedded in analog front end controller 110.

According to some embodiments, processor 116 is further coupled to a system 118. System 118 receives a signal 120 from processor which may be related to a capacitance value output from sensor 102. For example, sensor 102 may be a sensor for providing system navigation and, thus, may be used to provide position information to system 118. In particular, sensor 102 may be a navigation tool used to navigate and control a display position of a cursor output on a display 124 of system 118. Consistent with some embodiments, system 100 may be a system that is formed on a single substrate or PCB, wherein wiring within the substrate or PCB couple the discrete elements. In operation, processor 116 may provide a command signal 122 to analog front end controller 110 to convert the capacitance values from output from sensor 102 on leads 106 one at a time, and storing each value until all capacitance values have been read from sensor 102. These capacitance values may then be converted by processor 116 to a position value that is output to system 118. As noted above, the converted capacitance values may correspond to a position of a cursor displayed on display 124. However, the converted capacitance values may also be used for other control functions, such as, panning an image, selecting a displayed object, zooming in or out on display 124. Consistent with some embodiments, processor 116 continuously reads converted capacitance values output from CDC 108 through analog front end controller 110, but may only output a position value to system 118 when the position changes. In other words, system 118 assumes that a last reported position remains in effect until data processor 116 provides a position value to system 118 that is different than a previous position value.

As previously noted, consistent with some embodiments, processor 116 may convert capacitance values to a position value that is output to system 118. System 118 may then translate the position values to an abstract domain which may correspond to, for example, display 124 coupled to system 118. The translation of the position values typically requires mapping the range and resolution of the capacitance values from sensor 102 to a position on display 124. Consistent with some embodiments, an entire range of values that may be detected by sensor 102 may be mapped to an entire range of display values for display 124. While mapping an entire range of values that may be detected by sensor 102 to an entire range of display values may provide an ability for a user using sensor 102 as a positioning device to be able to quickly move a cursor on display 124 to any location on display 124, the quick movement of the cursor comes with decreased positional precision and accuracy. To increase accuracy at the expense of speed, the translation of the detected position values can be scaled down. For example, 100% translation scaling results in complete mapping of an entire range of values detected by sensor 102 to an entire display range of display 124. Scaling the translation to 50%, doubles the positional precision, but only allows a user to direct a cursor across a half of display 124. Similarly, scaling the translation to 25% means that a user's movement from one end of sensor 102 to another end of sensor 102 only moves the cursor across a quarter of display 124. Thus, consistent with some embodiments, capacitance values from sensor 102 may be treated as a displacement from a fixed starting position, such as a last detected position, instead of a true positional value in order to achieve both full range of movement and precision. Displacement from a fixed position may be achieved by designating a last detected capacitance value corresponding to a position on display 124 as being a last detected position such that subsequent detected capacitance values are converted to a position on display 124 with respect to a displacement from the last detected capacitance value. For example, considering a 50% scaling when a finger, stylus, or other object comes in contact with sensor 102 and changes the capacitance thereof, the computer system or data processor maps the capacitance value to a position displayed on display 124. If a last touch display position corresponds to a position in the middle of display 124, when an initial touch is detected on sensor 102 in a position corresponding to an upper left corner of display 124, the display position does not change. If the user then slides to the middle of sensor 102, the display position will move toward the lower right corner but stop at the halfway position. If the detected touch is then lifted, repositioned at the upper left corner of sensor 102, and the same slide repeated, the display position will move the rest of the distance to the lower right corner. Treating capacitance values from sensor 102 as a displacement from a last detected position allows a user to make multiple “scrolling” movements across sensor 102 to position a cursor from, for example, one side of display 124 to another side, while providing greater positional accuracy and position.

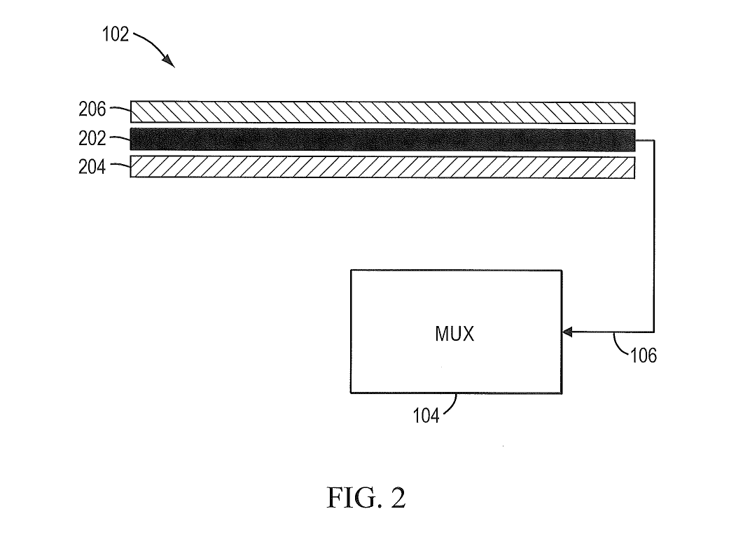

FIG. 2 is a diagram illustrating a cross section of sensor 102 across line II-II′ according to some embodiments. As shown in FIG. 2, sensor 102 includes a single electrode layer 202 deposited on a dielectric layer 204. Consistent with some embodiments, single electrode layer 202 may be a metallic layer, such as a layer of Indium Tin Oxide (ITO), and dielectric layer 204 may be a semiconductor substrate or a printed circuit board (PCB). As shown in FIG. 2, electrode layer 202 is coupled to multiplexer 104 by lead 106. If dielectric layer 204 is a PCB, lead 106 may correspond to a trace on PCB, and multiplexer 106 may also be integrated on PCB. According to some embodiments, electrode layer 202 may be covered by protective material 206, which may be a plastic shell made from ABS, a clear epoxy or resin, or other material which protects electrode layer 202 from the environment and also protect electrode layer 202 from electrostatic discharge. Moreover, protective material 206 may be made thin enough such that protective material 206 does not interfere with the capacitive sensing capabilities of electrode layer 202.

Consistent with some embodiments, capacitive touch sensor 102 measures self-capacitance. Measuring self-capacitance involves measuring a change in capacitance of a system in response to the touch or near touch of an object, such as a user's finger, that has its own capacitance. In operation, capacitive touch sensor 102 has a system capacitance G that, when an object is not touching, is equal to a parasitic capacitance G from electrode layer 202. When a an object, such as a user's finger, touches capacitive touch sensor 102, the object forms a simple parallel plate capacitor with electrode layer 202 and the result is an object capacitance Cₒ, wherein the object capacitance Cₒ is proportional to the area of overlap between the object and electrode layer 202. When the object is touching capacitive touch sensor 102, the system capacitance Cₛ is equal to the sum of the parasitic capacitance Cₚ and object capacitance Cₒ. Because the parasitic capacitance may be generally known, the system capacitance Cₛ will be proportional to an area of overlap between the object and electrode layer 202, circuitry coupled to capacitive touch sensor 102, such as processor 116, may determine the position on capacitive touch sensor 102 on which the touch is made, and can translate this position to a touch position or a position on display 124. Using a single electrode layer 202 and measuring self-capacitance allows for the manufacture of a capacitive touch sensor 102 that may be made much thinner than conventional multiple electrode layer capacitive touch sensors.

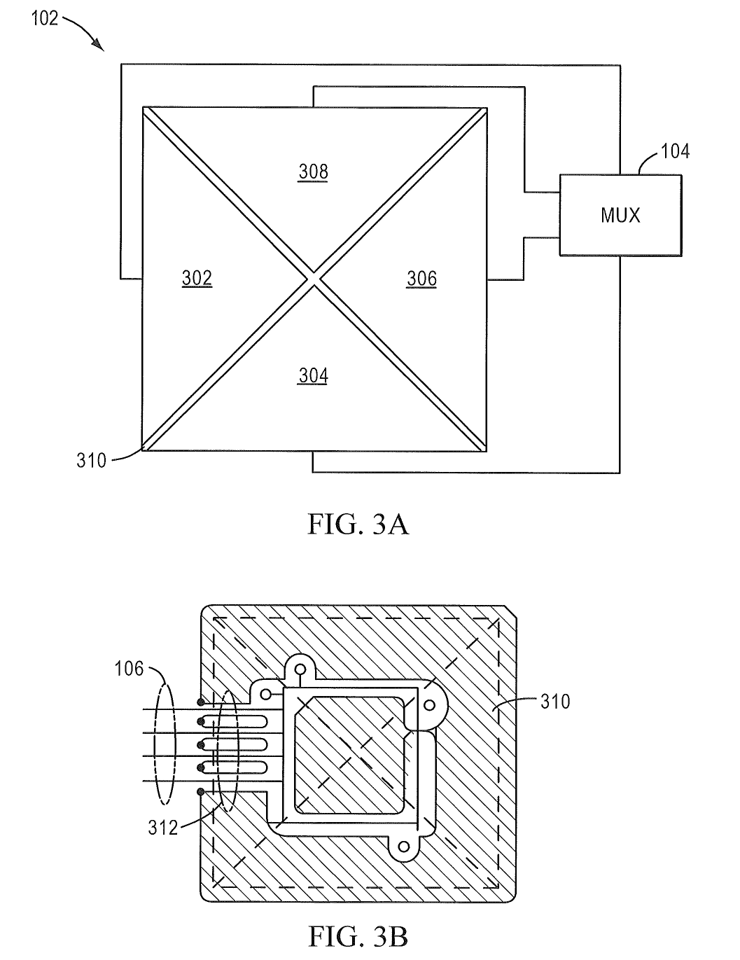

FIG. 3A is a diagram illustrating a capacitive touch sensor 102 consistent with some embodiments. As shown in FIG. 3A, capacitive touch sensor 102 includes two opposing single layer capacitive electrodes 304 and 308 formed on a substrate or PCB oriented along the y-axis and two opposing single layer capacitive electrodes 302 and 306 oriented along the x-axis. Consistent with some embodiments, capacitive touch sensor 102 includes an electrically non-conducting protective layer that, for example, may be made of a plastic such as ABS (not shown). Each electrode 302-308 is coupled to multiplexer 104 by separate leads 106. As shown in FIG. 3, electrodes 302-308 are triangular-shaped and each have the same surface area, however, electrodes 302-308 may have any shape. Each of electrodes 302-308 are electrically isolated from one another through isolation 310. According to some embodiments, isolation 310 is formed by a dielectric material to provide an insulator between electrodes 302-308. According to other embodiments, isolation 310 may simply be a gap of a predetermined width between electrodes 302-308. Consistent with some embodiments, electrodes 304 and 308 are used to measure a touch position in the y-direction and electrodes 302 and 306 are used to measure a touch position in the x-direction.

Consistent with some embodiments, capacitive touch sensor 102 measures a differential self-capacitance between the electrodes in each direction. That is, processor 116 determines a difference in the self-capacitance between y-axis electrodes 304 and 308 and a difference in the self-capacitance between x-axis electrodes 302 and 306. Processor 116 converts the differential self-capacitances in the x direction and the y direction to determine a two dimensional position on capacitive touch sensor 102 which may correspond to a position on display 124. Measuring the differential self-capacitance between two opposing capacitive electrodes provides advantages over conventional capacitive touch sensors which measure mutual capacitance between one or more capacitive electrode plates (multiple electrode layers) or even capacitive touch sensors that measure only the individual self-capacitance of each individual electrode. One of the advantages that measuring the differential self-capacitance between two opposing electrodes provides over conventional methods is providing very good common mode noise rejection.

Using capacitive touch sensors to measure self-capacitance is generally limited to measuring simple on/off behavior due to inherent poor precision and noise, and requires the complex interleaving of many electrode patterns to have nominal precision. Differential self-capacitance, on the other hand, measures the difference between two capacitive electrodes subjected to the same environment and can, thus, extract a high-resolution signal in the presence of significant common-mode noise. However, because the two opposing capacitive electrodes used to measure differential self-capacitance are subjected to the same environment, the common-mode noise resulting from the environment will be present on the readings from each electrode and will be removed from the reading when the difference between the two electrodes is calculated. That is, the differential capacitance calculated between two opposing electrodes effectively subtracts the environmental noise that is common to both of the opposing capacitive electrodes.

Returning to FIG. 3A, a processor 116 determines a differential capacitance between capacitive electrodes 302 and 306 to determine a touch position in the x-direction, and processor 116 determines a differential capacitance between capacitive electrodes 304 and 308 to determine a touch position in the y-direction. Thus, sensor 102 having electrodes 302-308 may be used to determine a two-dimensional position that is substantially free from common mode noise. That is, processor 116 calculates the differential capacitance in the x-direction Cₓ as being approximately C₃₀₂-C₃₀₆ and the differential capacitance in the y-direction C_{y} as being approximately C₃₀₄-C₃₀₈. Consistent with some embodiments, sensor 102 may be used as a user interface device, allowing a user to interface with system 118 and navigate display 124, as discussed above. Further consistent with some embodiments, sensor 102 having electrodes 302-308 may be fabricated to have a small size, for example, approximately the size of a fingertip. For example, sensor 102 may have a surface area of about 16 mm² to about 144 mm².

Moreover, electrodes 302-308 may be formed on a substrate or PCB by etching a top surface of substrate or PCB to form electrodes 302-308 or by depositing conductive material onto the top surface of substrate or PCB 302-308. Consistent with some embodiments, a shield may be formed on the bottom surface of the substrate or PCB. FIG. 3B is a diagram illustrating a partial shield formed on a bottom surface of a substrate or PCB, consistent with some embodiments. Because the differential capacitive sensing of sensor rejects common-mode noise, shielding is used only to prevent grounding from the bottom of sensor 102 raising the overall capacitance to a level that interferes with the determination of whether sensor 102 is touched or not. Shield 310 is a partial shield formed on a bottom side of the substrate or PCB, and shares the circuit layer of the substrate or PCB, filling the empty areas of the bottom side of the substrate or PCB. Shield 310 includes openings 312 for leads 106 to pass through, each of leads 106 being coupled to one of electrodes 302-308 and multiplexer 104. Shield 310 may be further coupled to analog front end controller 110 for receiving an excitation signal based on a capacitance level detected on electrodes 302-308 such that the shield 310 is driven to be at the same potential as electrodes 302-308. Driving shield 310 at a potential equivalent to the potential on electrodes 302-308 increases the accuracy of touch detection by sensor 102 by preventing sensor 102 from registering stray or parasitic capacitance on electrodes 302-308 as being a touch when a user is not touching electrodes 302-308.

According to some embodiments, sensor 102 does not include a shield such as shield 310. To increase accuracy of detecting a user touch when sensor 102 does not include a shield, processor 116 may implement an algorithm for distinguishing between common-mode and differential capacitance changes to automatically adjust the touch threshold to compensate for background capacitance caused by stray or differential capacitance in the vicinity of sensor 102. For example, processor 116 may recognize nearly equal capacitance changes simultaneously on all of electrodes 302-308 as a background change rather than a touch on sensor 102. Alternatively, or in combination, processor 116 may also recognize patterns of capacitance changes that distinguish a user touch from stray or parasitic capacitance changes. Consistent with some embodiments, the apparent touch position based on capacitance differences between opposing electrodes 302-308 varies considerably as, for example, a user finger approaches the front of sensor 102. The apparent position due to stray or parasitic capacitances may also vary. However, a plot of the finger position against time produces a continuous curve, whereas a similar plot for the stray and parasitic capacitances shows extreme direction reversals and changes in position that can be differentiated from that of the finger position. Consequently, processor 116 may implement algorithms to differentiate capacitance changes caused by a user touch from capacitance changes caused by stray or parasitic capacitance to allow the fabrication of sensor 102 without shield 310. The fabrication of sensor 102 without shield 310 allows for a less complex fabrication and further allows sensor 102 to be fabricated at a reduced thickness.

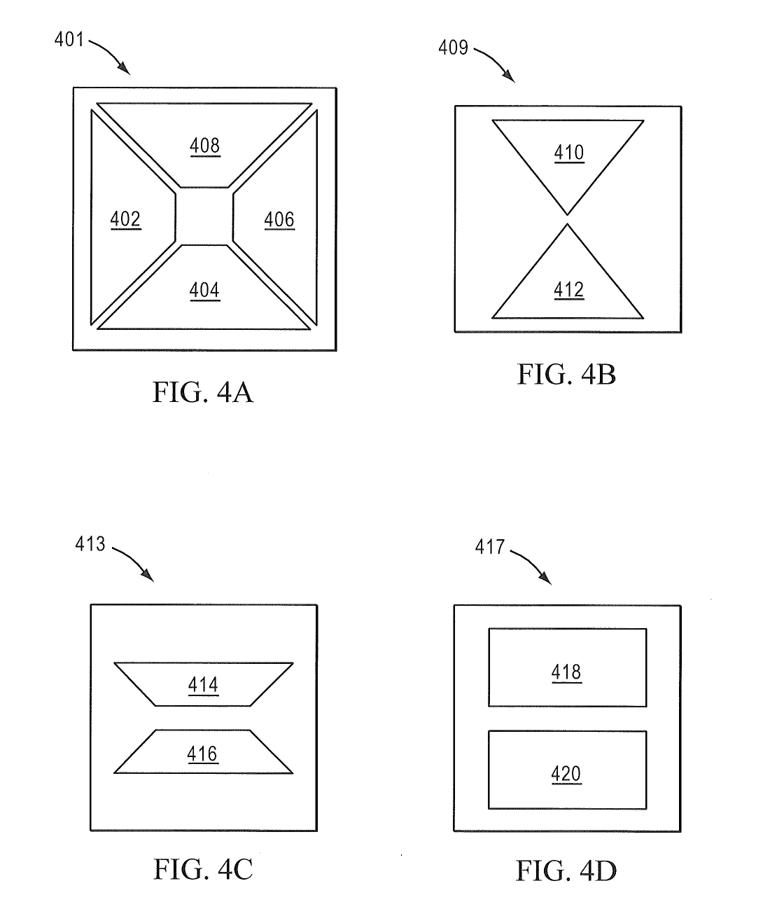

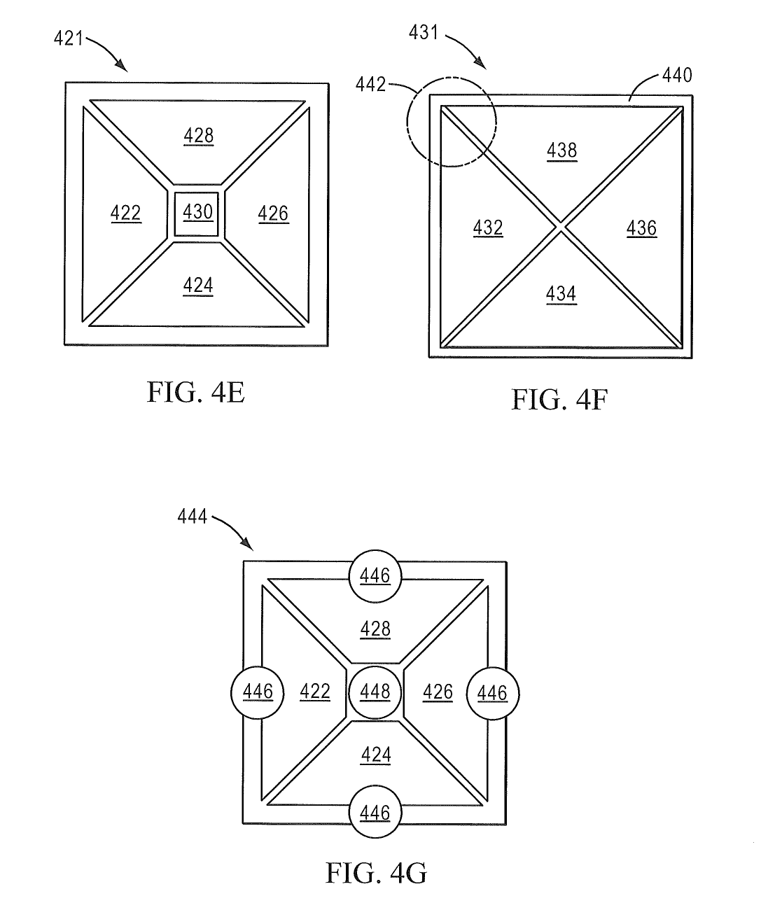

Although sensor 102 having electrodes 302-308 is shown as having four triangular-shaped electrodes in FIG. 3A, sensor 102 may have different numbers of electrodes in different shapes. FIGS. 4A-4G are diagrams illustrating additional exemplary electrode numbers and shapes for sensor 102. FIG. 4A is a sensor 401 having four capacitive electrodes 402, 404, 406, and 408 each having substantially identical surface areas. As shown in FIG. 4A, electrodes 402-408 correspond to trapezoids having a base along the edges of sensor 102. Consistent with some embodiments, electrodes 402 and 406 correspond to electrodes for detecting a touch position in the x-direction by determining a differential capacitance between electrodes 402 and 406 and electrodes 404 and 408 correspond to electrodes for detecting a touch position in the y-direction. by determining a differential capacitance between electrodes 404 and 408.

FIGS. 4B, 4C, and 4D illustrate one-dimensional sensors, consistent with some embodiments. As shown in FIG. 4B, sensor 409 includes two triangular-shaped electrodes 410 and 412 arranged vertically to provide position detection in the y-direction by determining a differential capacitance between electrodes 410 and 412. Alternatively, electrodes 410 and 412 may be arranged horizontally to provide position detection in the x-direction. As shown in FIG. 4C, sensor 413 includes trapezoidal-shaped electrodes 414 and 416 arranged vertically to provide position detection in the y-direction by determining a differential capacitance between electrodes 414 and 416. Alternatively, electrodes 414 and 416 may be arranged horizontally to provide position detection in the x-direction. As shown in FIG. 4D, sensor 417 includes rectangular-shaped electrodes 418 and 420 arranged vertically to provide position detection in the y-direction by determining a differential capacitance between electrodes 418 and 420. Alternatively, electrodes 418 and 420 may be arranged horizontally to provide position detection in the x-direction.

FIG. 4E is a diagram illustrating a capacitive touch sensor 421 having four trapezoidal-shaped capacitive electrodes 422, 424, 426, and 428 surrounding a central sensor 430. Similar to sensor 401 shown in FIG. 4A, electrodes 422 and 426 are used to detect a touch position in the x-direction by determining a differential capacitance between electrodes 422 and 426 and electrodes 424 and 428 are used to detect a touch position in the y-direction by determining a differential capacitance between electrodes 424 and 428. Consistent with some embodiments, central sensor 430 may be a capacitive electrode, similar to capacitive electrodes 422-428, or a tactile button, mechanical switch, or other similar sensor device. Central sensor 430 may provide additional functionality to the two-dimensional position sensing provided by sensor 421 in FIG. 4E. Such additional functionality includes providing increased accuracy, a scrolling function, or a selection or tap functionality to touch sensor 421.

FIG. 4F is a diagram illustrating a sensor 431 similar to sensor 102 shown in FIG. 3A, having triangular-shaped electrodes 432-438 for providing positional detection in the x-direction and in the y-direction by determining a differential self-capacitance between opposing electrodes in the x and y-direction. However, sensor 431 in FIG. 4F further provides an electrode ring 440 surrounding electrodes 432-438. Consistent with some embodiments, electrode ring 440 is used to provide greater positional detection accuracy at the edges and corners of sensor 431 than may be provided using triangular-shaped electrodes 432-438. As can be seen in FIG. 4F, the overall electrode area of electrodes 432 and 438 at corner is small and, thus, accurate positional detection is difficult to achieve at corner 442. Consequently, electrode ring 440 provides additional area surrounding corner 442 to provide greater accuracy around corner 442, and other corners and edges of sensor 431. Consistent with some embodiments, capacitance measured by ring electrode 440 may be measured as a differential capacitance, wherein the capacitance measured by ring electrode 440 is compared with the closest electrode of electrodes 432-438. According to other embodiments, capacitance measured by ring electrode 440 may be measured as an absolute value, and the absolute value may be interpreted by processor to provide an indication of the amount of capacitance present at the edges which can be used to compensate the differential capacitance readings obtained from electrodes 432-438.

FIG. 4G is a sensor similar to sensor 421 shown in FIG. 4E, having trapezoidal-shaped electrodes 422-428. However, as shown in FIG. 4G, sensor 444 also includes dome switches 446 formed within a periphery of trapezoidal-shaped electrodes 432-438, and a dome switch 448 in a center of sensor 444 within a gap formed by the shorter parallel side of trapezoidal-shaped electrodes 432-438. Consistent with some embodiments, dome switches 446 and 448 may be formed on the same substrate or PCB as trapezoidal-shaped electrodes 432-438, and may be used to provide tactile feedback or coarse position indication for a user. Further consistent with some embodiments, sensor 444 may be covered by a shell or plastic, as discussed previously, such that the shell or plastic covering dome switches 446 and 448 is thinner than the shell or plastic covering trapezoidal-shaped electrodes 432-438 such that a uniform level surface is provided to a user. Further consistent with some embodiments, dome switches 446 may be arranged around the periphery of each of the trapezoidal-shaped electrodes 432-438 such that each of the trapezoidal-shaped electrodes 432-438 wrap around one of the plurality of dome switches 446. Although electrodes 432-438 are illustrated in FIG. 4G as being trapezoidal-shaped, the shape is not important, and electrodes 432-438 may have any shape, including but not limited to a triangular shape or a rectangular shape.

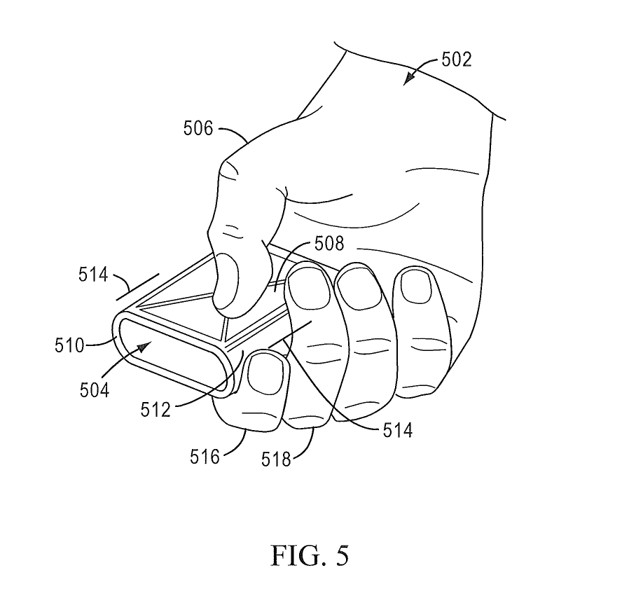

Consistent with some embodiments, a capacitive touch sensor measuring a differential self-capacitance of opposing electrodes to determine a touch position in two dimensions, such as sensor 102, 401, 409, 413, 417, 421, 431, or 444, may be capable of detecting a position in a third dimension as well. FIG. 5 is a diagram of a user holding a system having a capacitive touch sensor capable of three-dimensional position detection. As shown in FIG. 5, a user 502 is holding a differential capacitive touch sensor system 504 in their hand 506. System 504 includes differential capacitive touch sensor 508 and circuitry (not shown) encased within a housing 510 of system 504. The circuitry may include a multiplexer, and analog front end controller, and a processor, similar to system 100 shown in FIG. 1. Moreover, system 504 may be coupled to a system having a display (not shown), wherein the user is capable of navigating the display and selecting elements displayed on the display using system 504. The coupling between system 504 and the external system having a display may be a wired coupling or a wireless coupling. Housing 510 may include a shell 512 that covers sensor 508. Shell 512 includes flexible sides 514 and may be made of plastics, such as ABS, or acrylics or other suitable materials, and may completely cover sensor 508 such that sensor 508 is not exposed to the external environment.

Consistent with some embodiments, sensor 508 is not internally shielded allowing for the capacitance measured on the electrodes of sensor 508 to be measurably altered based on a proximity of fingers 516 and 518 to a back side of sensor 508. Thus, when hand 506 firmly presses on flexible shell 512, shell 512 deforms bringing fingers 516 and 518 closer to sensor 508 beneath shell 512, which increases the capacitance measured on sensor 508 resulting from the proximity of fingers 516 and 518. In particular, the proximity capacitance increases the capacitance detected on all of the electrodes of sensor 508 such that the uniform increase in capacitance on all of the electrodes of sensor 508 may be interpreted by the circuitry as movement in the z-direction. Similarly, relaxing hand 506 will return shell 512 to its original shape and fingers 516 and 518 will move away from sensor 508 beneath shell 512 resulting in a decrease in capacitance measured on all electrodes of sensor 508. The z-direction sensing provided by system 502 allows a user to press down to navigate in the z-direction or to use sensor 508 as a button for selecting interactive elements displayed by a display coupled to system 502.

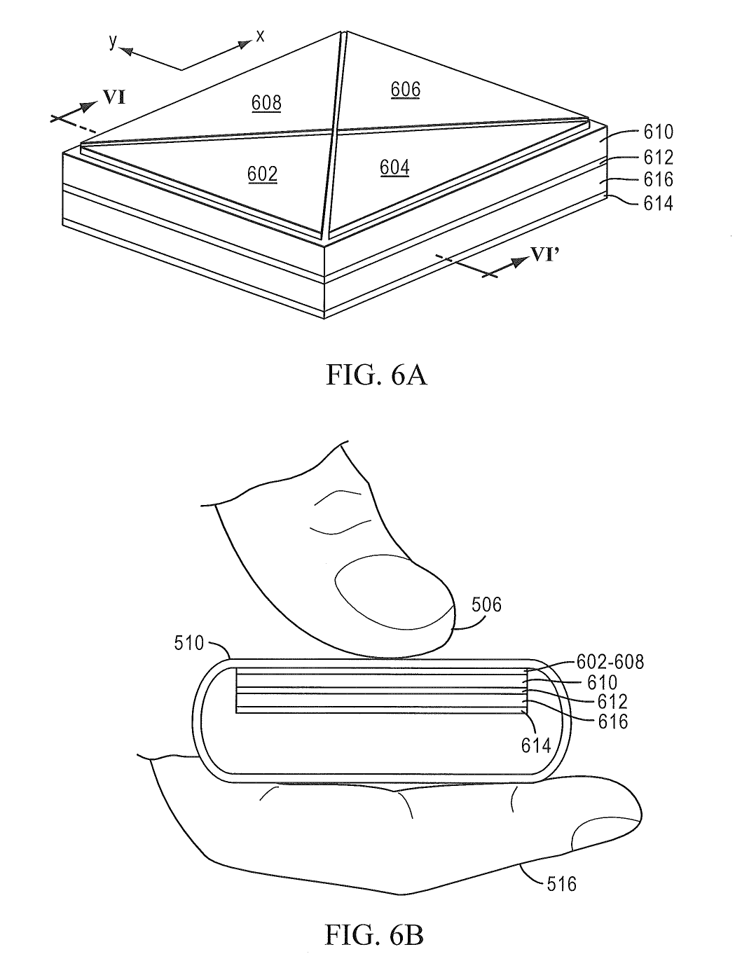

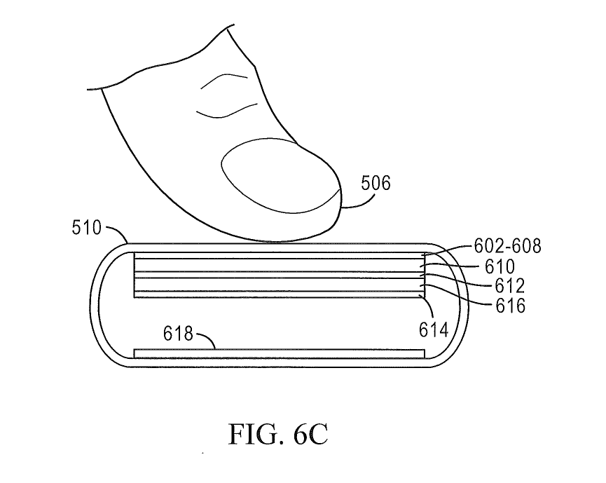

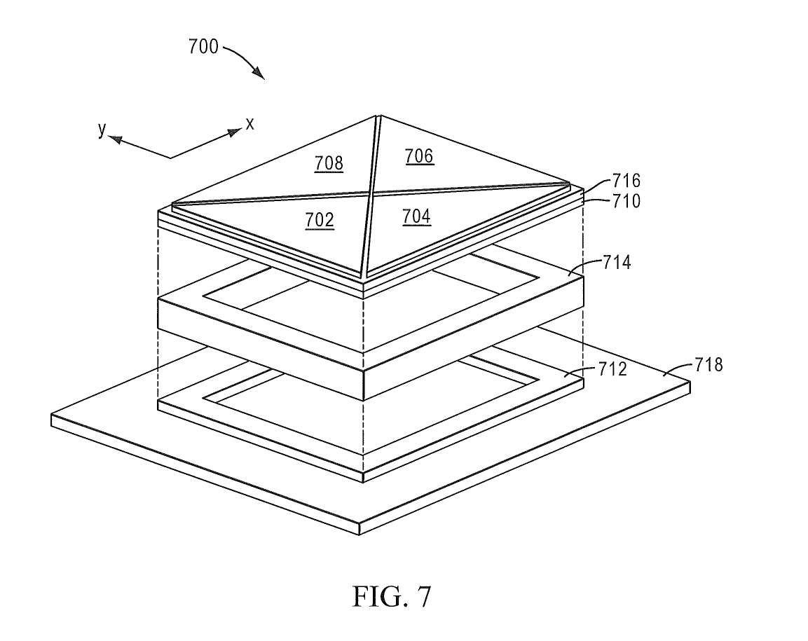

FIG. 6A is a diagram illustrating a capacitive touch sensor for measuring a touch position in three dimensions, consistent with some embodiments. As shown in FIG. 6A, sensor 600 includes capacitive electrodes 602, 604, 606, and 608, formed on a substrate or PCB 610. Electrodes 602-608 are coupled to circuitry (not shown) for determining an x-y touch position. Consistent with some embodiments, capacitive electrodes 602 and 606 detect a position in the x-direction by determining a differential capacitance between electrodes 602 and 606, and capacitive electrodes 604 and 608 detect a position in the y-direction by determining a differential capacitance between electrodes 604 and 608. Although electrodes 602-608 are shown as being triangular-shaped, electrodes 602-608 may be any shape, such as trapezoids, as discussed herein. Sensor 600 further includes a driven shield 612. Driven shield 612 is coupled to circuitry (not shown) that drives shield 612 to the same potential as at least one of electrode 602-608 that is currently under test in order to prevent sensor 600 from detecting stray or parasitic capacitances and only being activated when a user is touching sensor 600. Sensor 600 further includes a z-axis electrode 614 formed on an additional substrate or PCB layer 616. Z-axis electrode 614 is also coupled to circuitry (not shown), wherein the circuitry determines a change in the capacitance of z-axis electrode 614 based on a distance between a user's hand located behind the assembly and z-axis electrode 614. Similar to sensor 504 in FIG. 5, sensor 600 may be enclosed in a housing having a flexible shell such that when a user presses firmly on sensor 600, the flexible shell is compressed, and the user's finger or hand becomes closer to z-axis electrode 614 increasing the measured capacitance on z-axis electrode 614. Although sensor 600 is similar to sensor 504, sensor 600 is physically more complex than sensor 504 but may simplify associated signal processing by making z-axis information independent of x- and y-axes.

FIG. 6B is a cross-section of sensor 600 shown in FIG. 6A taken along the line VI-VI′ enclosed in a flexible shell 510 and held by a user's hand. When the user's thumb 506 presses on sensor 600, z-axis electrode 614 moves closer to the user's finger 516 located behind the assembly, increasing the capacitance seen on electrode 614. FIG. 6C is a cross-section of sensor 600 shown in FIG. 6A taken along the line VI-VI′ enclosed in a flexible shell 510 and held by a user's hand similar to FIG. 6B but with an additional ground plane 618 located on the inside of shell 510 opposite z-axis electrode 614. Ground plane 618 may comprise metallization of the shell itself or a separate conductive element. Pressing firmly on sensor 600 moves z-axis electrode 614 closer to ground plane 618, increasing the capacitance seen on electrode 614. The user's finger 516 shown in FIG. 6B serves no electrical role. The more consistent z-axis measurement environment of this compared to the embodiment of FIG. 6B may afford a more consistent response and simplify z-axis signal processing. This embodiment may also be used where the user does not hold the assembly.

FIG. 7 is a diagram illustrating a capacitive touch sensor capable of detecting a touch in three dimensions, consistent with some embodiments. As shown in FIG. 7, sensor 700 includes four capacitive electrodes 702, 704, 706, and 708. Consistent with some embodiments, a differential capacitance between electrodes 702 and 706 may be measured to determine a touch position in an x-direction and a differential capacitance between electrodes 704 and 708 may be measured to determine a touch position in a y-direction. Although electrodes 702-708 are shown as having a triangular shape, the shape of electrodes 702-708 may be chosen from any shape as long as electrodes 702-708 have the same surface area. As shown in FIG. 7, sensor 700 includes an upper conductive ring 710 and a lower conductive ring 712 separated by a conductive elastomer 714. Electrodes 702-708 are separated from upper conductive ring by an insulative layer 716, and lower conductive ring 712 is mounted on a substrate or PCB 718. Upper and lower conductive rings 710 and 712 connect conductive elastomer 714 to circuitry (not shown) that measures an electrical resistance of conductive elastomer 714. When a user presses on a flexible shell enclosing sensor 700, the resistance through conductive elastomer 714 decreases, which can be detected by circuitry to determine a z-axis touch position.

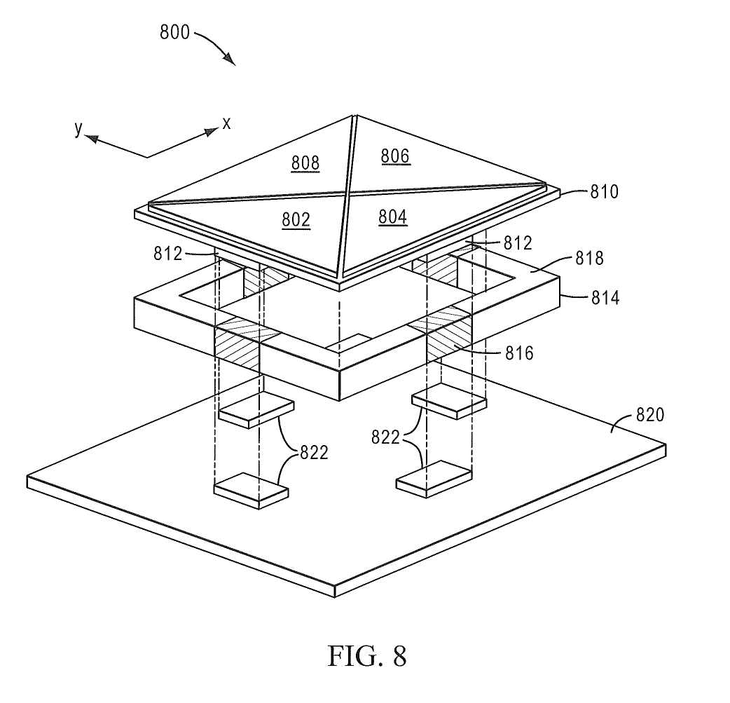

FIG. 8 is a diagram illustrating a capacitive touch sensor that is also capable of detecting a pressure of a touch, consistent with some embodiments. As shown in FIG. 8, sensor 800 includes four capacitive electrodes 802, 804, 806, and 808. Consistent with some embodiments, a differential capacitance between electrodes 802 and 806 may be measured to determine a touch position in an x-direction and a differential capacitance between electrodes 804 and 808 may be measured to determine a touch position in a y-direction. Although electrodes 802-808 are shown as having a triangular shape, the shape of electrodes 802-808 may be chosen from any shape as long as electrodes 802-808 have the same surface area. Electrodes 802-808 may be formed on a substrate or PCB having an insulative layer 810 and four conductive electrodes 812 on the underside of insulative layer 810. Each of the four conductive electrodes 812 is located in the middle of one side of the touch area. Sensor 800 also includes an elastomer layer 814 comprising non-conductive portions 818 and four conductive portions 816. Sensor 800 further includes a substrate or PCB 820 on which four conductive electrodes 822 are formed and on which elastomer layer 814 and electrodes 802-808, and insulative layer 810 are mounted. Conductive electrodes 812, conductive elastomer portions 816, and conductive electrodes 822 are aligned

Consistent with some embodiments, sensor 800 combines properties of both a touch sensor and a joystick by adding pressure sensing to the accurate positional detection in the x- and y-direction provided by electrodes 802-808. Similar to sensor 700 shown in FIG. 7, each aligned pair of conductive electrodes 812 and 824 is connected to circuitry that measures resistance and, particularly, the resistance of the conductive elastomer 816 directly between the two electrodes, which varies with pressure applied to sensor 800. By providing electrodes 812 and 824 and conductive elastomer 816 at multiple locations, a pressure applied to sensor 800 can be interpreted as movement in either the x or y direction based on the changing resistance across elastomer layer 814. Thus, a user can use sensor to provide both pressure-based displacement sensing, similar to a joystick, and actual displacement, by measuring a touch position through the differential capacitance on electrodes 802-808. Alternatively, sensor 800 can be used to detect pressure applied to sensor as being indicative as movement in the z-direction, similar to sensor 700 of FIG. 7.

Moreover, the pressure and displacement sensing capabilities of sensor 800 can be combined to improve a user's control when using sensor 800 as an input or navigation device. As discussed herein, with small displacement input devices it is difficult to map the device input area to the display area. With a one-to-one mapping, the user can traverse the entire display with one slide of the finger but fine positioning is impossible. The mapping can be changed to improve fine position but at the expense of requiring multiple swipes to traverse the full display. Variable mapping based on finger movement speed is feasible but is non-intuitive for most users and takes time for the user to adapt. If the user's slide across electrodes 802-808 is aborted by reaching the limit of electrodes 802-808, the natural tendency is to push harder to continue. The additional pressure provided by pushing harder could be detected by sensor 800 and translated into additional movement in the x- or y-direction.

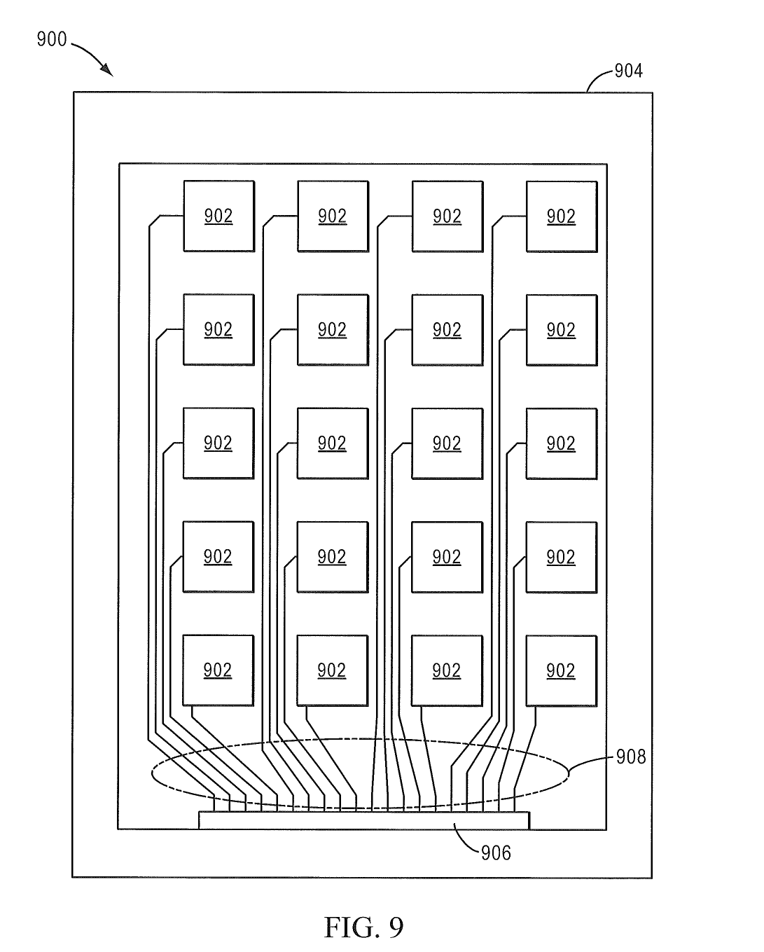

Consistent with some embodiments, differential capacitive touch sensors as described herein may be used as sensing elements in a touch screen device. FIG. 9 is a diagram illustrating a touch screen having multiple differential capacitive touch sensors, consistent with some embodiments. As shown in FIG. 9, a touch screen 900 includes a plurality of differential capacitive sensors 902 arranged in rows and columns to substantially cover the surface area of a screen 904 of touch screen 900. Each differential capacitive sensor 902 is coupled to circuitry 906, which may include a multiplexer, by separate leads 908. Consistent with some embodiments, each differential capacitive sensor 902 is fabricated as a single electrode layer over a substrate or PCB. The single electrode layer may be a conductive material such as indium tin oxide (ITO). Differential capacitive sensors 902 measure a self-capacitance and, further, a difference in capacitance between itself and a neighboring sensor 902.

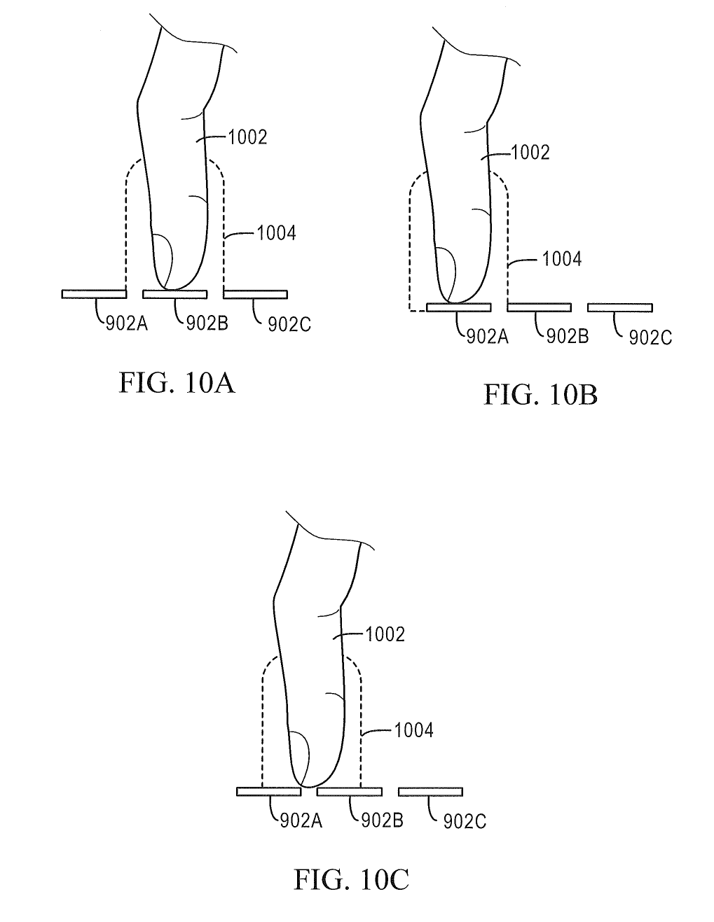

FIGS. 10A, 10B, and 10C are diagrams illustrating measuring the differential capacitance of adjacent self-capacitive sensors, consistent with some embodiments. As shown in FIG. 10A, a finger 1002 is touching an approximate center point of self-capacitive sensor 902B, which is between self-capacitive sensors 902A and 902C. When finger 1002 is at the center point of sensor 902B, the effects of finger 1002 are detected at the edges of both sensors 902A and 902C. If the distance 1004 between adjacent sensors is too great, then the effects of finger 1002 would not be felt at adjacent sensors 902A and 902C. Consequently, distance 1004 shown in FIG. 10A represents a minimum distance between sensors to prevent dead spots. As shown in FIG. 10B, as finger 1002 moves towards sensor 902A, the capacitive effects of finger 1002 are seen on sensor 902A and sensor 902B. Then, as finger 1002 moves back towards sensor 902B, the capacitive effects are seen on sensors 902A and 902B, as shown in FIG. 10C. Consistent with some embodiments, circuitry 906 is programmed with the distance between the middle of sensors 902A-902C and maps the touch position of finger 1002 detected by sensors 902A-902C absolutely to the underlying display.

Consistent with some embodiments, touch screen 900 provides advantages over conventional touch screens as only one conductive layer is required for sensor fabrication. Moreover, by measuring a differential capacitance between adjacent sensors 902, common mode noise is substantially rejected, as all sensors 902 are exposed to the same common mode noise. Moreover, the wiring required for touch screen 900 is about the same is required for a conventional mutual capacitance touch screen.

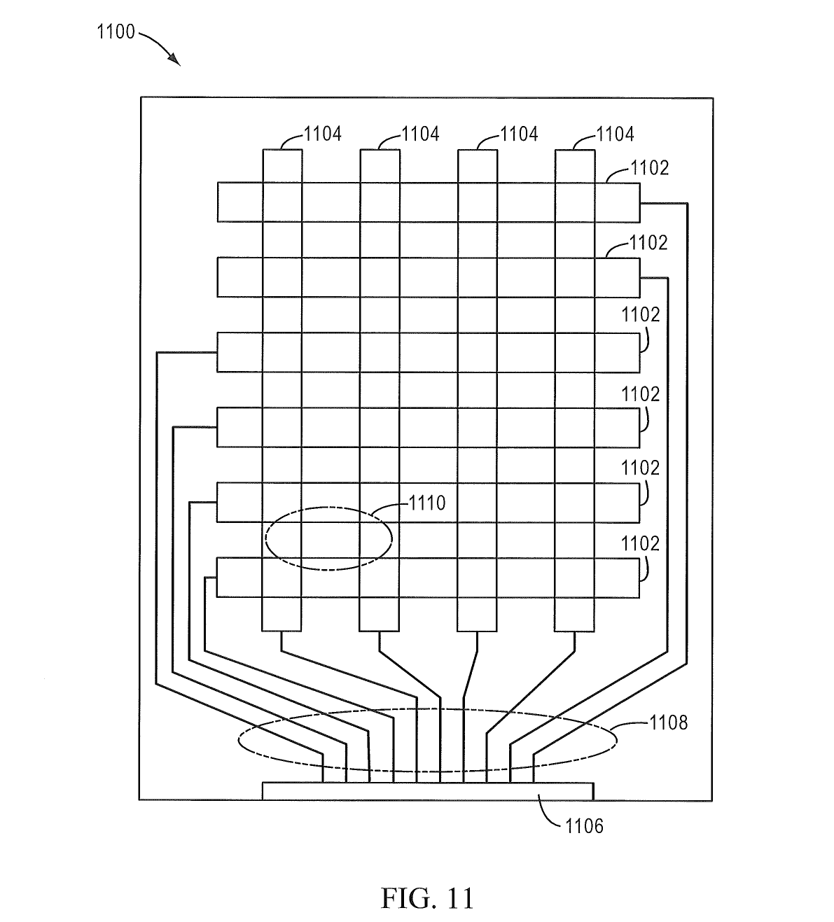

The concept of measuring the differential capacitance of adjacent electrodes can be applied to a mutual-capacitive touch screen. FIG. 11 is a diagram illustrating a mutual-capacitive touch screen that measures the differential capacitance of adjacent electrodes, consistent with some embodiments. As shown in FIG. 11, touch screen 1100 includes a grid of horizontal electrodes 1102 and vertical electrodes 1104 separated by an insulative layer. Horizontal and vertical mutual capacitance electrodes 1102 and 1104 are coupled to circuitry 1106 by leads 1108 coupled to each electrode. A typical touch screen measures a mutual capacitance between horizontal and vertical electrodes 1102 and 1104 such that a user touch at the intersection of horizontal electrode 1102 and vertical electrode 1104 changes the capacitive coupling between the two. Typically, the charge on the driven electrode is split between the reading electrode and the grounded body of the user, effectively reducing coupling. Circuitry 1106 would recognize this change as a touch. In a conventional mutual capacitance touch screen, position resolution is typically twice the electrode spacing because a touch that appears on two adjacent electrodes is interpreted as occurring exactly between the two. However, circuitry 1106 can achieve much higher resolution with touch screen 1100 by measuring the differential capacitance between two adjacent electrodes in the range of the capacitive influence caused by a user touch. The mutual capacitance between horizontal and vertical electrodes 1102 and 1104 provides precise absolute positioning of low resolution while the differential capacitance between adjacent horizontal or vertical electrodes 1102 and 1104 provides high resolution that is made precise by being referenced to the absolute positions determined by the grid. For example, in FIG. 11, a vertical position of a user touch at user touch area 1110 is determined by the offset from either of the horizontal electrodes 1102 in the region indicated by the differential capacitance therebetween. Similarly, the horizontal position could be determined by the offset from either of the vertical electrodes 1104 in the region indicated by the differential capacitance therebetween.

Thus, consistent with some embodiments, a differential capacitance can be measured between adjacent pairs of horizontal or vertical electrodes 1102 to provide accurate positioning on touch screen. Moreover, this would require very little modification to touch screen 1100, as the modifications would only be implemented in circuitry. Consequently, a conventional mutual capacitance touch screen having horizontal and vertical electrodes 1102 and 1104 could be essentially reprogrammed to measure differential capacitance between adjacent electrodes. Alternatively, a user could designate only a finite area on touch screen to measure differential capacitance, such as touch area 1110, such that the designated area can be used as a touch sensor for providing mouse or trackball-like navigation on touch screen 1100. User could designate the area through a command that would instruct circuitry 1106 to read touch area 1110 as an area of differential capacitance measurement.

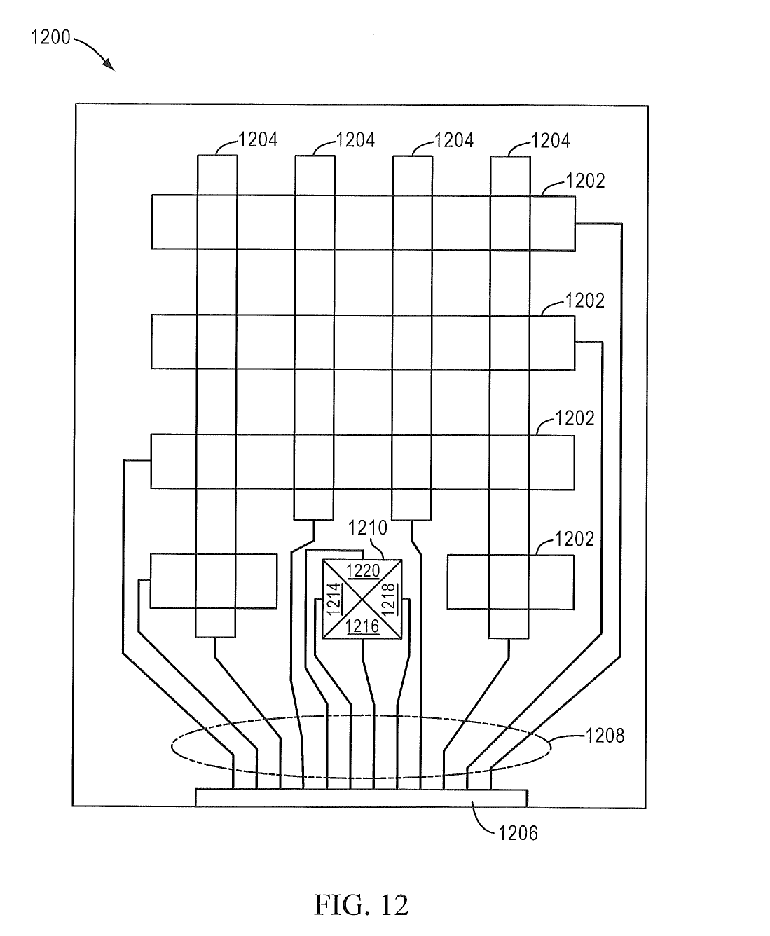

Consistent with some embodiments, a differential capacitance touch sensor may be added to a conventional mutual capacitance touch screen to provide a precise positional navigation device for a touch screen. While the touch screen would be used for most applications, a differential capacitance touch sensor could be used to provide mouse-like navigation of a cursor on the touch screen. FIG. 12 is a diagram illustrating a mutual capacitance touch screen having a differential capacitance touch sensor, consistent with some embodiments. As shown in FIG. 12, touch screen 1200 includes a grid of horizontal electrodes 1202 and vertical electrodes 1204 separated by an insulative layer. Electrodes 1202 and 1204 are connected to circuitry 1206 by leads 1208. Circuitry 1206 uses mutual capacitance coupling between horizontal and vertical electrodes to determine the position of a touch. Touch screen 1200 also includes a differential capacitance touch sensor 1210 coupled to circuitry 1206 by leads 1212. Consistent with some embodiments, differential capacitance touch sensor 1210 may include four triangular shaped single layer electrodes 1214, 1216, 1218, and 1220, each measuring a differential self-capacitance between opposing electrodes 1214 and 1218 and 1216 and 1220, similar to sensor 102 shown in FIG. 3. According to some embodiments, differential capacitance touch sensor 1210 may measure a touch position of a user to provide a mouse or trackball-like navigation of touch screen 1200.

According to some embodiments, differential capacitance touch sensor 1210 may be fabricated independently of horizontal and vertical electrodes 1202 and 1204. Consistent with other embodiments, single layer electrodes 1214-1220 may be coupled to horizontal and vertical electrodes in order to reduce wiring. For example, each single layer electrode 1214-1220 may be coupled to a different horizontal or vertical electrode 1202 or 1204 by a conductor. The coupling would be chosen such that the simultaneous appearance of a touch on all four could not happen under normal operation and would, therefore, indicate that the user was touching differential capacitance touch sensor 1210. Detecting this, circuitry 1206 could switch to the differential capacitive position measurement mode of operation for detecting signals from electrodes 1214-1220.

Consistent with embodiments described herein, a capacitive touch sensor having at least one pair of opposing electrodes may be provided to allow for the measuring of a differential capacitance between the at least one pair of opposing electrodes providing a capacitive touch sensor having improved precision and substantially complete common mode noise rejection. Such a capacitive touch sensor may be used as a navigation device for navigating on a display. Moreover, such a capacitive touch sensor may be about the size of a human fingertip, providing an accurate, yet compact, navigation device. Furthermore, capacitive touch sensors as described herein may be formed on a substrate or PCB and, thus, may be integrated onto the substrates or PCBs of existing devices. Capacitive touch sensors as described herein may use electrodes having any shape, and may be have additional electrodes formed on below the substrate or PCB to allow for three-dimensional position sensing. Finally, capacitive touch sensors as described herein may be used as touch position sensors in touch screen devices. The examples provided above are exemplary only and are not intended to be limiting. One skilled in the art may readily devise other systems consistent with the disclosed embodiments which are intended to be within the scope of this disclosure. As such, the application is limited only by the following claims.

What is claimed is:

1. A touch sensor, comprising:
at least two capacitive sensing electrodes, each of the at least two capacitive sensing electrodes having a surface area that is smaller than an area of a touch from a user, the at least two capacitive sensing electrodes comprising:
a substrate;
a single conductive element formed on the substrate; and
electronic circuitry coupled to the at least two capacitive sensing electrodes for measuring a self-capacitance of the at least two capacitive sensing electrodes, wherein:
a position corresponding to the touch of a user is determined by the electronic circuitry based on a difference of the measured self-capacitance between the at least two capacitive sensing electrodes.

2. The sensor of claim 1, wherein:
the at least two capacitive sensing electrodes each have a rectangular shape and are arranged to be abutting.

3. The sensor of claim 1, wherein the at least two capacitive sensing electrodes each have a trapezoidal shape and are arranged to be abutting.

4. The sensor of claim 1, wherein:
the at least two capacitive sensing electrodes comprises four capacitive sensing electrodes arranged around a central area such that leading edges of the four capacitive sensing electrodes are equidistant from the central area; and
the electronic circuitry determines a two-dimensional position corresponding to the touch of a user based on a first difference of the measured self-capacitance between two capacitive sensing electrodes arranged in a first direction and a second difference of the measured self-capacitance between two capacitive sensing electrodes arranged in a second direction.

5. The sensor of claim 4, further comprising:
a switch coupled in the central area, wherein the four capacitive sensing electrodes have a trapezoidal shape and are arranged around the switch.

6. The sensor of claim 1, wherein:
the at least two capacitive sensing electrodes comprises four capacitive sensing electrodes, each of the at least two capacitive sensing electrodes having a triangular shape and having an equal surface area.

7. The sensor of claim 1, wherein the sensor is used as a user interface device, the determined position corresponding to a position on a display.

8. The sensor of claim 1, wherein the sensor is used in a touch screen, the determined position corresponding to a position on the touch screen.

9. A capacitive touch sensor, comprising:
at least two capacitive electrodes, the at least two capacitive electrodes each being formed on a substrate and having a single electrode layer, wherein:
the at least two capacitive electrodes are arranged to oppose each other along an axis for determining a touch position along the axis;
circuitry coupled to the at least two capacitive electrodes, the circuitry configured to determine a differential self-capacitance between the at least two capacitive electrodes.

10. The capacitive touch sensor of claim 9, wherein:
the at least two capacitive electrodes comprises four capacitive electrodes, a first capacitive electrode arranged opposite a second capacitive electrode along a first axis, and a third capacitive electrode arranged opposite a fourth capacitive electrode along a second axis; and
the circuitry determines a touch position along the first axis by determining a differential self-capacitance between the first and second capacitive electrodes and determines a touch position along the second axis by determining a differential self-capacitance between the third and fourth capacitive electrodes.

11. The capacitive touch sensor of claim 10, further comprising:
a fifth capacitive electrode under the substrate, wherein:
the circuitry determines a touch position along a third axis based on a distance between a user touch on a back of the sensor and the fifth capacitive electrode.

12. The capacitive touch sensor of claim 10, further comprising:
a fifth capacitive electrode under the substrate; and
a grounded plane positioned opposite the fifth capacitive electrode with a space therebetween, wherein:
the circuitry determines a touch position along a third axis based on a distance between the grounded plane and the fifth capacitive electrode.

13. The capacitive touch sensor of claim 10, further comprising:
a plurality of switches arranged along a periphery of each of the capacitive electrodes, the switches being coupled to the circuitry and being configured to provide additional touch positional information to the circuitry.

14. The capacitive touch sensor of claim 13, wherein the plurality of switches are arranged such that each of the capacitive electrodes wraps around one of the plurality of switches.

15. The capacitive touch sensor of claim 10, further comprising:
a first conductive ring coupled to a printed circuit board;
a conductive elastomer formed above the first conductive ring, the conductive elastomer coupled to the circuitry; and
a second conductive ring formed above the conductive elastomer and coupled to the substrates of the capacitive electrodes, wherein:
a resistance of the conductive elastomer changes based on a distance between the first and second conductive rings; and
the circuitry determines a pressure based on the resistance of the conductive elastomer.

16. The capacitive touch sensor of claim 15, wherein the circuitry determines a touch position along the first or second axis based on the determined pressure.

17. The capacitive touch sensor of claim 15, wherein the circuitry determines a position along a third axis based on the resistance of the conductive elastomer.

18. The capacitive touch sensor of claim 10, wherein the capacitive touch sensor is embedded in a touch screen device.

19. The capacitive touch sensor of claim 10, wherein the combined surface area of the four electrodes is about the average surface area of a human fingertip.

20. The capacitive touch sensor of claim 9, wherein the circuitry is coupled to a display such that the determined touch position corresponds to a position on the display.

21. The capacitive touch sensor of claim 9, wherein the circuitry rejects substantially all of any common mode noise caused by an environment around the capacitive touch sensor.
